(19) United States
(12) Patent Application Publication
(10) Pub. No.: US 2007/0173369 A1
(43) Pub. Date: Jul. 26, 2007

(54) Electromechanical gear clutch

(75) Inventors: Emmanuel Jacques Eyraud, Nieuwegein (NL); Hendrikus Jan Kapaan, Nieuwegein (NL); Jacobus Zwarts, Nieuwegein (NL); Paul Bernard Meaney, Utrecht (NL); Cornelius Petrus Antonius Vissers, Den Dungen (NL)

Correspondence Address: YOUNG & THOMPSON, 745 SOUTH 23RD STREET, 2ND FLOOR, ARLINGTON, VA, 22202, US

(73) Assignee: AB SKF, GOTEBORG (SE)

(21) Appl. No.: 10/551,954

(22) PCT Filed: Apr. 8, 2004
(86) PCT No.: PCT/NL04/00230

§ 371 Date: Aug. 23, 2006

(30) Foreign Application Priority Data
Apr. 10, 2003 (NL) 1023145

(51) Int. Cl. F16H 3/44

(52) U.S. Cl. 475/293; 475/302

(57) ABSTRACT

A clutch includes a housing, an input shaft and an output shaft rotatably supported with respect to the housing, a drive gear set and a control gear set each comprising a first gear, a number of pinion gears, a carrier onto which the pinion gears are mounted, and a second gear, each pinion gear meshing with the corresponding first gear and second gear of the gear set, as well as control elements for influencing the rotation of a first or second gear of the control gear set. The first gear of the drive gear set is connected to the input shaft, the carrier of the drive gear set is connected to the output shaft and the second gear of the drive gear set is connected to the carrier of the control gear set.

The invention is related to an electromechanical clutch, which can be applied in automotive vehicles between the engine and the rest of the drive train. The clutch can for instance be connected to a gear box or to a continuously variable transmission.

The object of the invention is to provide an electromechanical clutch which is of an improved, efficient design. This object is achieved by means of a clutch, comprising a housing, an input shaft and an output shaft rotatably supported with respect to the housing, a drive gear set and a control gear set each comprising a first gear, a number of pinion gears, a carrier onto which the pinion gears are mounted, and a second gear, each pinion gear meshing with the corresponding first gear and second gear of the gear set, as well as control means for influencing the rotation, controlled by a sensor e.g. encoder sensor, of a first gear or a second gear of the control gear set, wherein the first gear of the drive gear set is connected to the input shaft, the carrier of said drive gear set is connected to the output shaft and the second gear of said drive gear set is connected to the carrier of the control gear set, the first gear of the control gear set being connected to the output shaft and the second gear of said control gear set being connected to the control means.

In the clutch according to the invention efficient use is made of the power which is applied for the control means which drives the control gear set. This power is added to the power generated by the engine which is to be connected to the input shaft of the clutch. Thus, at the output shaft the sum of the power fed to the control means as well as fed to the input shaft is obtained, which is beneficial when driving off or when accelerating the vehicle in question.

After the clutch has established a normal connection between the input shaft and the output shaft, that is without any rotational speed differences, the action of the control means can be stopped in case a coupling mechanism is provided for selectively establishing a rotatable or a non-rotatable connection between the input shaft and the output shaft. Said coupling means are preferably associated with the first gear of the drive gear set and the second gear of the control gear set. In particular, the first gear of the drive gear set and the second gear of the control gear set have facing surfaces which each carry a part of the coupling means, such as radially extending ridges and grooves.

With the aim of enabling the coupling action, the first gear of the drive gear set and the second gear of the control gear set are axially moveable with respect to each other for transferring said gears between a coupled and an uncoupled condition. the coupled condition can be ascertained when the first gear of the drive gear set and the second gear of the control gear set are spring biased towards each other.

The uncoupled condition can then be obtained by means of an electromagnetic actuator for moving the first gear of the drive gear set and the second gear of the control gear set away from each other against the biasing force. The coil of the actuator is connected to the housing, and the armature thereof is connected to the electromagnetic actuator is connected to the second gear of the control gear set.

The second gear of the control gear set is supported rotatably with respect to the output shaft by means of a disc member, said second gear also being axially slidable with respect to said disc. Said disc is at the side of said the second gear facing away from the coupling means, the armature protruding through the disc and the biasing means being provided between the disc and said second gear.

The first gear of the drive gear set and the carrier of the control gear set are rotatably supported with respect to each other, e.g. by means of a rolling element bearing. Furthermore, the first gear of the drive gear set is connected to the input shaft through a spring damper.

The control means may comprise an electric motor, the stator of which is connected to the housing and the rotor of which is connected to the second gear of the control gear set.

The first gear of the drive gear set may have means, e.g. an external toothing, for engagement with a starter motor. Alternatively, the first gear of the drive gear may be connected to the rotor of a starter motor, the stator of which is connected to the housing.

The gear sets can be carried out in different forms, dependent on the lay-out of the clutch and the sizes thereof. According to a first embodiment, the first gear and the second gear of the drive gear set are face gears. Alternatively however, the control gear set is a planetary gear set, the first gear being the sun gear and the second gear being the ring gear of said planetary gear set.

The invention will now be described further with reference to the embodiments shown in the drawings.

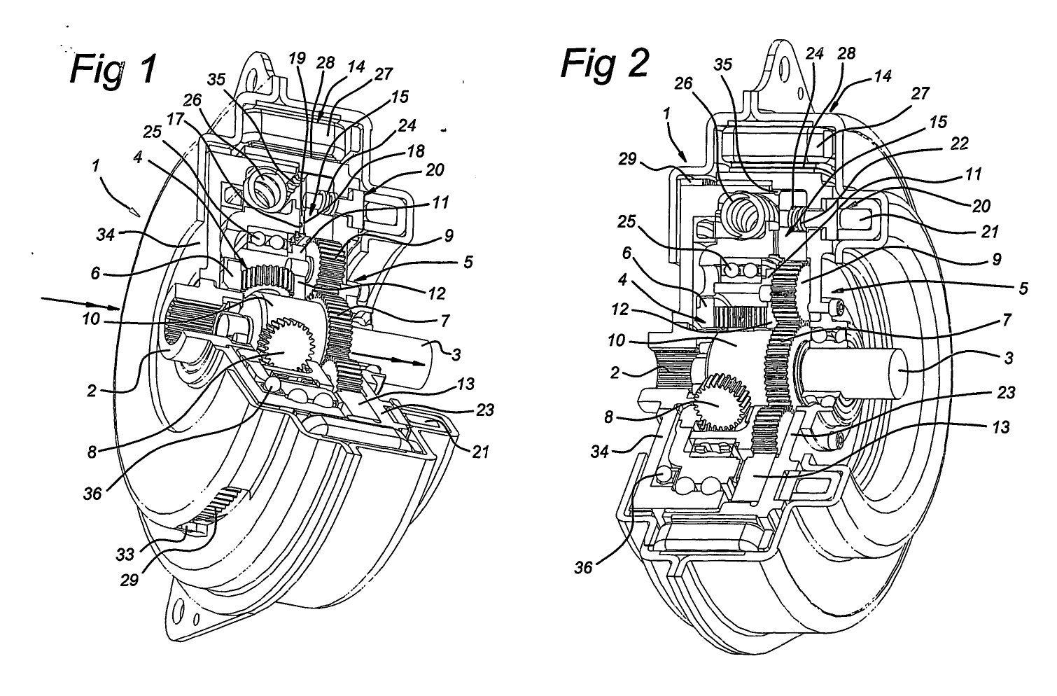

FIGS. 1 and 2 show view in perspective, partially in radial cross section, of a first embodiment of a clutch according to the invention.

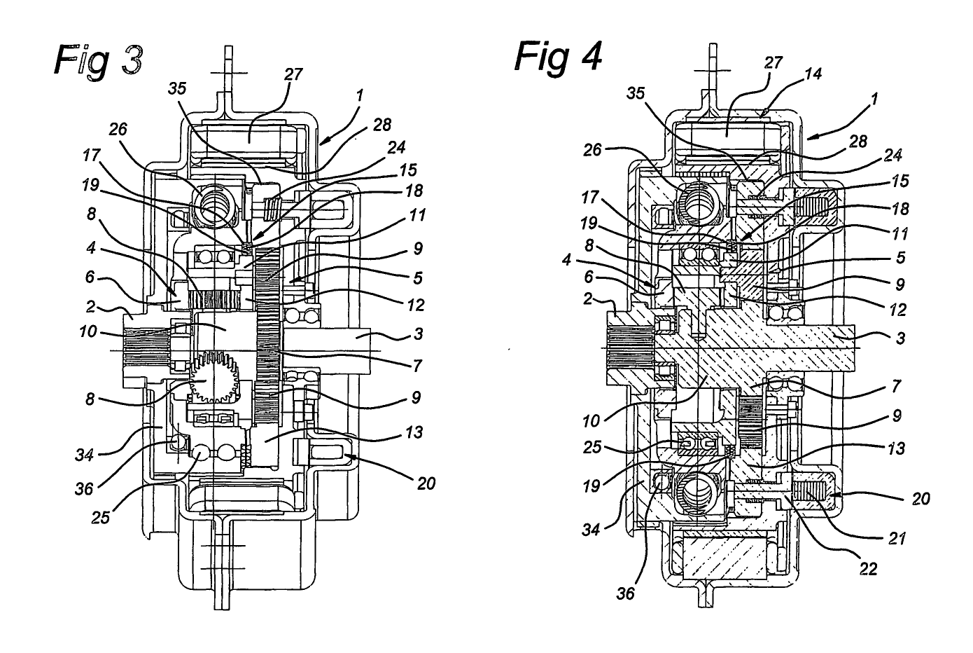

FIG. 3 shows a front view of the embodiment according to FIGS. 1 and 2.

FIG. 4 shows a radial cross section of the embodiments according to FIGS. 1 and 2.

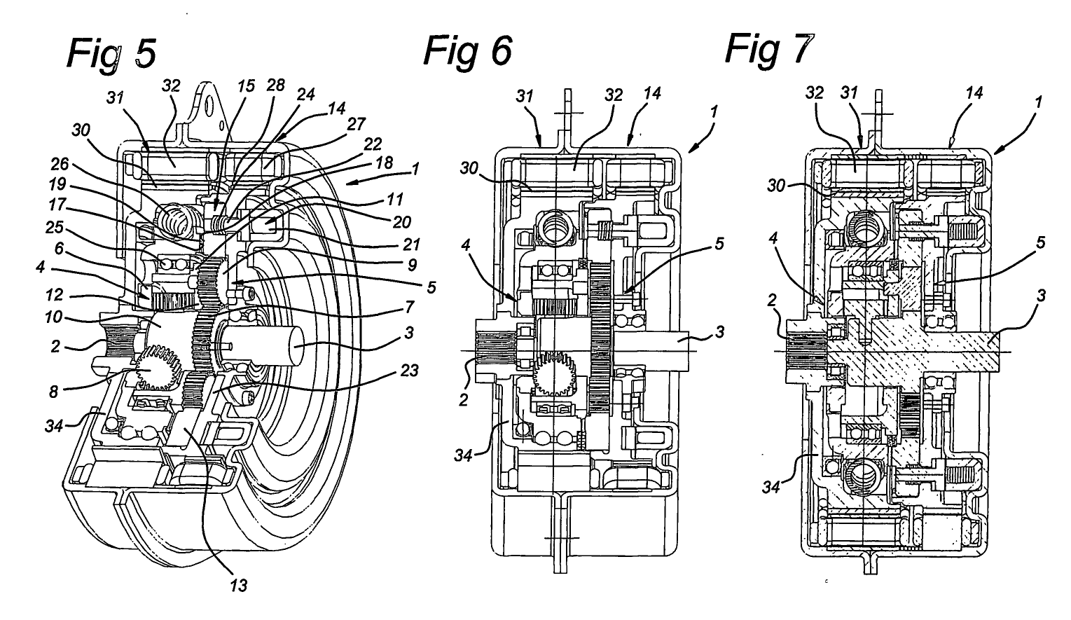

FIG. 5 shows a view in perspective, partially in radial cross section of a second embodiment.

FIG. 6 shows a front view of the embodiment of FIG. 5.

FIG. 7 shows a radial cross section of the embodiment according to FIG. 5.

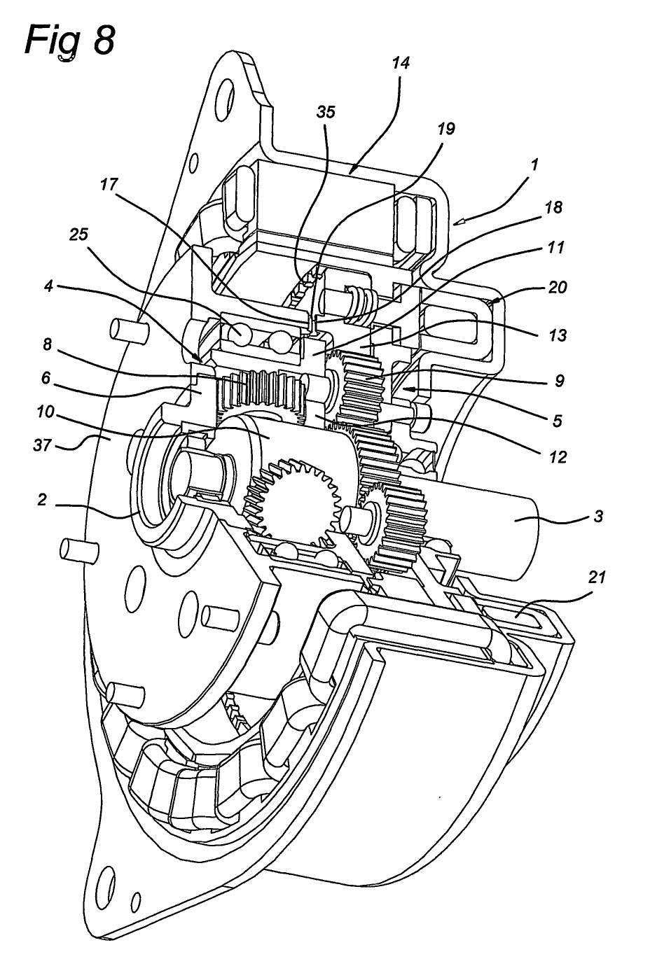

FIG. 8 shows a third embodiment.

The clutch shown in the FIGS. 1 up to 4 comprises a housing provided with openings from which an input shaft 2 and an output shaft 3 respectively protrude. Furthermore, the housing 1 contains a drive gear set 4 and a control gear set 5. The drive gear set 4 consists of a first face gear 6 and a second face gear 12 which both mesh with a number of pinion gears 8. The control gear set 5 is carried out as a planetary gear set 5 having a sun gear 7, a ring gear 13 and a number of satellite gears 9.

Furthermore, control means 14 are provided which are carried out as an electric motor, the stator 27 of which is connected to the housing 1, and the rotor 28 of which is connected to the ring gear 13 of the planetary gear set 5.

The pinions 8 of the drive gear set 4 are supported by a carrier 10 which is connected to the output shaft 3. The first face gear 6 of the drive gear set 4 is connected to the input shaft 2, and the second face gear 12 of the drive gear set 4 is connected to the carrier 11 of the control gear set 5. This carrier 11 supports the satellite gears 9 of said control gear set 5. The sun gear 7 of the control gear set 5 is connected to the output shaft 3, and the ring gear 13 is connected to the rotor 28 of the electric motor 14, as mentioned above.

Furthermore, a coupling mechanism 15 is provided which as shown is in the disengaged state. This means that the input shaft 2 and the output shaft 3 are freely rotatable with respect to each other. The coupling means have facing surfaces 17 and 18, provided with ridges and grooves 19.

The surface 17 is connected to the first face gear 6 of the drive gear set 4, and the surface 18 is carried by the second or sing gear 13 of the control gear set 5. Through the toothed connecting 35, said ring gear 13 is axially moveable but non-rotatable with respect to the first face gear 6 of the drive gear set 5. By means of springs 24, the facing surfaces 17, 18 are constantly urged in engagement with each other. Furthermore, an electromagnetic actuator 20 is provided, comprising a coil 21 and an armature 22. By energizing coil 21, the armature 22 is moved against the force of the springs 24, thus bringing the facing surfaces 17, 18 out of engagement with each other.

The first face gear 6 of the drive gear set 4 and the carrier 11 of the control gear set 5 are rotatably supported with respect to each other by means of rolling element bearing 25. The first face gear 6 of the drive gear set 4 is connected to the input shaft 2 through spring dampers 26. Furthermore, the first face gear 6 of the drive gear set 4 has an external toothing 29, which through the window 33 can engage a starter motor (not shown).

The embodiment of FIGS. 5 up to 6 is to a large extend identical to the embodiment of FIGS. 1 up to 4, except for the starting arrangement. As shown in FIGS. 5 up to 7, the drive gear set 4 is now connected to the rotor 30 of a starter motor 31, the stator 32 which is connected to the housing.

The clutch according to the embodiments shown before functions as follows. In the disengaged state of the facing surfaces 17 and 18 it is after energizing coil 21, the engine onto which the clutch according to the invention is connected, is started. In the embodiment of FIGS. 1 up to 4 this occurs by means of a starter motor engaging the toothing 29, in the embodiment of the FIGS. 5 up to 7 this occurs by energizing the starter motor 31.

When the motor has been started, the input shaft 2 is rotating in the direction indicated by the double headed arrow in the left of FIG. 1. Possible shocks during starting have been damped out by the springs 26. The rotating movement is transferred from the input shaft 2, via the disc 34 connected therefore, and the springs 26 onto the first face gear 6 of the drive gear set 4. As the output shaft 3 is stationary, both the carrier 10 for the pinions as well as the sun gear 7 are stationary. This means that the face gear 6 makes the pinion gears 8 rotate about their own axes only, as a result of which the second face gear 7 and thus the carrier 11 rotates in opposite direction to the double headed arrow left in FIG. 1. Consequently, also the rotor 28 of the motor 14 is rotating in this opposite direction.

With the aim of making the output shaft 3 rotate in the same direction, that is according to the double headed arrow as well, the motor 14 is energized. Thereby, the rotation of the rotor 28 is slowing down, which means that the energy provided by the motor 14 provided a positive contribution to the power transferred to the output shaft 3. Thus, the output shaft 3 obtains both the power from the engine connected to the input shaft 2 as well as the power of the electromotor 14. As soon as the input shaft 2 and the output shaft 3 rotate at the same number of revolutions, also the facing teeth 17 and 18 rotate at the same speed. At that point in time, the coil 21 is de-energized whereby the grooves and ridges 19 come to grasp into each other. The input shaft 2 and output shaft 3 are now fixedly connected to each other, whereby a normal driving condition is obtained.

The embodiment of FIG. 8 is to a large extend similar to the former embodiments. However, in this simplified embodiment no springs 26 for damping purposes have been incorporated. The first face gear 6 of the drive gear set 4 is now directly connected to the facing surface 17 with grooves and ridges 19.

The unit, comprising a spring damper and/or a balancing unit and/or a starter motor or a starter gear can be connected to the flange 37. A balancing unit 36, known per se, is connected to the disc 34 for balancing the complete arrangement. The electric motor 14 can act as a booster, not only upon clutching but also during normal driving conditions with the clutch fully engaged. Also the starter motor 31 of the embodiment according to FIGS. 5-7 can act as such a booster.

Control sensors are provided which are e.g. in closed loop configuration with the controls of a transmission such as a continuously variable transmission. The aim thereof is to provide an efficient shift transmission system, which for instance prevents slip in the belt/disc contact configuration of the continuously variable transmission.

The control systems can be a part of the overall car management system. The clutch systems as described before can be applied for road or off-road vehicles, industrial applications such as lathes etc.

1. Clutch, comprising a housing (1), an input shaft (2) and an output shaft (3) rotatably supported with respect to the housing (1), a drive gear set (4) and a control gear set (5) each comprising a first gear (6, 7), a number of pinion gears (8, 9), a carrier (10, 11) onto which the pinion gears (8, 9) are mounted, and a second gear (12, 13), each pinion gear (8, 9) meshing with the corresponding first gear (6, 7) and second gear (12, 13) of the gear set (4, 5), as well as control means (14) for influencing the rotation of a first gear (7) or a second gear (13) of the control gear set, wherein the first gear (6) of the drive gear set (4) is connected to the input shaft (2), the carrier (10) of said drive gear set (4) is connected to the output shaft (3) and the second gear (12) of said drive gear set (4) is connected to the carrier (11) of the control gear set (5), the first gear (7) of the control gear set (5) being connected to the output shaft (3)and the second gear (13) of said control gear set (5) being connected to the control means (4).

2. Clutch according to claim 1, wherein a coupling mechanism (15) is provided for selectively establishing a rotatable or a non-rotatable connection between the input shaft (2) and the output shaft (3).

3. Clutch according to claim 2, wherein the coupling means (15) are associated with the first gear (6) of the drive gear set (4) and the second gear (13) of the control gear set (5).

4. Clutch according to claim 3, wherein the first gear (6) of the drive gear set (4) and the second gear (13) of the control gear set (5) have facing surfaces (17, 18) which each carry a part of the coupling means (15).

5. Clutch according to claim 4, wherein the coupling means (15) comprise radially extending ridges and grooves (19).

6. Clutch according to claim 3, wherein the first gear (6) of the drive gear set (4) and the second gear (13) of the control gear set (5) are axially moveable with respect to each other for transferring said gears (6, 13) between a coupled and an uncoupled condition.

7. Clutch according to claim 6, wherein the first gear (6) of the drive gear set (4) and the second gear (13) of the control gear set (5) are spring biased towards each other.

8. Clutch according to claim 7, wherein an electromagnetic actuator (20) is provided for moving the first gear (6) of the drive gear set (4) and the second gear (13) of the control gear set (5) away from each other against the biasing force.

9. Clutch according to claim 8, wherein the coil (21) of the actuator (20) is connected to the housing (1), and the armature (22) thereof is connected to the second gear (13) of the control gear set (5).

10. Clutch according to claim 9, wherein the second gear (13) of the control gear set (5) is supported rotatably with respect to the output shaft by means of a disc member (23), said second gear (13) also being axially slidable with respect to said disc member (23).

11. Clutch according to claim 10, wherein the disc member (23) is positioned at the side of said the second gear (13) facing away from the coupling means (15), the armature (22) protruding through the disc member (23) and the biasing means (24) being provided between the disc member (23) and said second gear (13).

12. Clutch according to claim 1, wherein the first gear (6) of the drive gear set (4) and the carrier (11) of the control gear set (5) are rotatably supported with respect to each other, e.g. by means of a rolling element bearing (25).

13. Clutch according to claim 1, wherein the first gear (6) of the drive gear set (4) is connected to the input shaft (2) through a spring damper (26).

14. Clutch according to claim 1, wherein the control means (14) comprise an electric motor, the stator (27) of which is connected to the housing (1) and the rotor (28) of which is connected to the second gear (13) of the control gear set (5).

15. Clutch according to claim 1, wherein the first gear (6) of the drive gear set (4) has means, e.g. an external toothing (29), for engagement with a starter motor.

16. Clutch according to claim 1, wherein the first gear (6) of the drive gear (4) is connected to the rotor (30) of a starter motor (31), the stator (32) of which is connected to the housing (1).

17. Clutch according to claim 1, wherein the first gear (6) and the second gear (12) of the drive gear set (4) are face gears.

18. Clutch according to claim 1, wherein the control gear set (5) is a planetary gear set, the first gear being the sun gear (7) and the second gear being the ring gear (13) of said planetary gear set (5).

19. Clutch according to claim 1, wherein a sensor, for instance an encoder sensor is provided for providing information to the control means.

20. Clutch according to claim 1, wherein different modules are applied e.g. a clutch module, a damper module, a balancing module, etc.

21. Clutch according to claim 1, wherein several parts can be made of metallic or non-metallic components, composite, powder, sheet metal material components etc.
